(19) United States
(12) Patent Application Publication
(10) Pub. No.: US 2017/0223423 A1
(43) Pub. Date: Aug. 3, 2017

(54) SYSTEM AND METHOD FOR SECURE CROSS-PLATFORM VIDEO TRANSMISSION

(71) Applicant: BrowsePlay, Inc., Tucson, AZ (US)

(72) Inventors: Addison HARDY, San Francisco, CA (US); Carl V. VENTERS, III, Wilmington, NC (US); Zephrin LASKER, Mill Valley, CA (US)

(73) Assignee: BrowsePlay, Inc., Tucson, AZ (US)

(21) Appl. No.: 15/502,476

(22) PCT Filed: Aug. 11, 2015
(86) PCT No.: PCT/US15/44652

§ 371 Date: Feb. 7, 2017

Related U.S. Application Data
(60) Provisional application No. 62/035,593, filed on Aug. 11, 2014.
(60) Provisional application No. 62/106,011, filed on Jan. 21, 2015.

(51) Int. Cl. H04N 21/643; H04N 21/2381; H04N 21/2387; H04N 21/61; H04N 21/858; H04N 21/2343; H04N 21/254

(52) U.S. Cl. CPC H04N 21/64322; H04N 21/2343; H04N 21/2381; H04N 21/2541; H04N 21/6125; H04N 21/8586; H04N 21/2387

(57) ABSTRACT

A system and method for transmitting video over a network, e.g., the Internet, securely without the need of third-party video players or plugins. The system and method may be particularly useful for mobile web applications. The system and method may provide mechanisms that authenticate and authorize users of video, tracks usage and distribution, and enables high quality video to be delivered instantly in all popular browsers, making it a truly cross platform distribution system. By freeing video as an element from the restrictions of the <video> tag, video can be displayed and manipulated as images are currently while maintaining digital rights management (DRM) security. Website backgrounds and other major design elements may be rendered in video that can be marked up, written onto, and potentially deep-linked to links to the products by multiple techniques.

This application claims benefit and priority to U.S. Provisional Application No. 62/106,011 filed Jan. 21, 2015 and also to U.S. Provisional Application No. 62/035,593 filed Aug. 11, 2014, the disclosures of which are incorporated by reference herein in their entirety.

### BACKGROUND

Field of the Invention

The present disclosure generally relates to secure cross-platform video over a network and, more particular, the disclosure generally relates to a system and method for providing secure cross-platform video over a network such as the Internet, among other features.

2.0 Related Art

Video is a basic element of digital content and its importance is only increasing as users or produce massive amounts of video, such as, e.g., with their cell phones or tablet computers. Bandwidth and connection speeds are generally improving, and more companies and individuals are become content producers to deliver content of various types across that bandwidth. For example, video is quickly becoming one of the most important and heavily shared formats on the web, especially for mobile users.

Video transmitted over the Internet is typically either free or for sale. For video business models that require security, conditional access, tracking and/or secure financial transactions, digital rights management (DRM) systems or techniques are often used to protect the content from unauthorized viewing, copying and/or piracy. Current DRM enabled video solutions (e.g., Adobe Flash™, Google Widevine™, Microsoft Silverlight™, and the like) require installed plug-ins, costly hardware certifications and repetitive user software installs to enable DRM protection. The growing dominance of mobile devices as primary media consumption vehicles adds a further complicating factor; current DRM video solutions were designed for the web, they do not work well (or sometimes at all) on mobile platforms.

However, flexibility of features for video is generally limited. For example, current video player solutions for mobile can only play video in a full screen takeover, black box player format. Moreover, there is little ability, e.g., for integrating video as a background in mobile and tablet accessible websites. Video is, metaphorically put, for mobile devices: “locked in a box on mobile and tablets.”

Video in the web browser has traditionally been restrained to the confines and parameters of the many proprietary video players available. These players typically require a proprietary codec, which is the term used to describe specific video encoding technologies. The players are plug-ins, or applications that are added to the HTML browser, typically by the user, and usually because a website will not usually play a video until the player has downloaded and installed the appropriate plug-in. A typical user browser may have multiple plug-ins, all being discrete software programs that typically need ongoing updates, are prone to crashing (and may also crash the browser), and in the case of battery-powered laptops and smart phones, can drain the power of the battery in an excessive way.

Even though these traditional players can be sized and placed on a web page, the video is a separate element and stays within the frame of the player. Even though the video is moving, it is static in that it is not suitable for enabling interactive features. For example, the video cannot have hot-linked and clickable elements that can take the user to other resources and content. Essentially, the current players are acting as if there are small TV screens inserted inside the web page and they are designed to just play the video. The web designer has very few options and is quite restricted in how it can be used.

A web designer may have other choices, often difficult choices, to make when it comes to handling video. For example, considerations might include which player to use, the specific codec, resolution, player/codec licensing costs, and bandwidth costs, and the like. In the case of the mobile market, many players are simply not supported by specific operating systems (OS) and with new mobile operating systems entering the market, supporting every phone OS will become a more daunting problem.

Media owners often demand DRM (digital rights management) to protect their content from unauthorized viewing, copying and piracy. However current DRM-enabled video solutions require cumbersome plug-ins, costly hardware certifications and annoying user software installs to enable DRM protection. The growing dominance of mobile and tablet devices as primary media consumption vehicles adds a further complicating factor; current DRM video solutions were designed for the web, they do not work well (or sometimes at all) on mobile and tablet platforms.

### SUMMARY OF THE DISCLOSURE

The present disclosure overcomes the limitations and problems as described above, plus provides additional benefits.

In one aspect, a system and method referred to as BrowsePlay are provided using HTML such as HTML5, Secure Conditional Access, Authentication, Authorization, Tracking and Media Rights Management techniques to provide multiple features including but not limited to the following illustrative capabilities: secure, authenticate and authorize application and media streams in browser-based environments, provide secure smooth video streaming without need of a proprietary player.

In one aspect, a system for providing video comprises a least one server platform configured to: extract a plurality of video frames from a video file containing a video, construct a second file comprising the plurality of video frames, a player embedded in a computing device configured to receive the second file and to playback the plurality of video frames therein at a predetermined rate to reproduce the video on a display, wherein the video frames are marked-up using a mark-up language. The mark-up language may comprise HTML5. The server platform may be configured to mark-up the video frames. The mark-up may be associated with at least one object within the video frames. The plurality of video frames may contain at least one hotlink that is activatable at the computing device during playback of the video frames. The hotlink may be configured to redirect upon activation to a website during playback of the video frames. The player may playback the second file without a plug-in being required. The second file may contain a header conveying at least one of: video speed indicating the predetermined rate to play back the plurality of video frames, a size of the second file. A portion of the reproduced video may be zoomable during playback to create a zoomed video image. The zoomed video image may continue playback at the predetermined rate.

In one aspect, a method of providing creating a video comprises extracting a plurality of video frames from a video file containing a video, creating a second file comprising: a header conveying a speed of the video, the plurality of extracted video frames, wherein the extracted video frames are marked-up. The method may further comprise storing the extracted video frames in a plurality of first files, wherein each extracted video frame is stored in a separate file. The mark-up extracted video frames may be marked-up using HTML5. The header may further include a size of the second file. A number of the extracted video frames may be related to a size of the video file and the speed of the video contained in the video file. The method may further comprise embedding the second file in a website. The method may further comprise applying at least one hotlink to the plurality of extracted video frames. The plurality of extracted video files may be configured to be zoomable during playback. The method may further comprise selecting at least one portion or at least one object within the video and marking-up the selected portion or selected object so that the selected potion or selected object is responsive when selected by a user during playback of the extracted plurality of video frames. The method may further comprise creating a file of the plurality of extracted video frames and applying digital rights management to the file. The digital rights management controls at least one of: (i) access to the file, (ii) access to a part of the file, (iii) access to the file based upon authorized access, (iv) forwarding the file to another user on a network and (v) payment.

In one aspect, a player for playing video comprises a software module embedded in a computing device configured to: playback and display a video from a file comprising a plurality of video frames and a header, the header indicting a speed to play the plurality of video frames in sequence, react to a selection by a user to process a selected portion of an image of the video being displayed causing new content to be displayed during playback. The plurality of frames may be marked-up and the software module reacts based on the user section and the marked-up plurality of frames. One or more images or objects within the plurality of video frames may be marked-up. The one or more images or objects within the plurality of video frames may be hotlinked and selection of the one or more images or objects causes new information to be displayed during playback. The one or more images or objects within the plurality of video frames may be hotlinked and selection of the one or more images or objects causes redirection to a website during playback. The plurality of video frames may be zoomable based on an input causing enlargement of a portion of an image being displayed during playback of the plurality of video frames. The enlarged portion of the image may play at a same rate as the plurality of video frames. The computing device may require no plug-ins to playback the file.

In one aspect, a method of providing creating a video comprises extracting a plurality of video frames from a video file containing a video, computing a delta change information between each extracted video frame and a next extracted video frame, create a second file comprising: a header conveying a speed of the video; the delta change information for each extracted video frame and each next extracted video frame; wherein the extracted video frames are marked-up, wherein the second file is configured to be played-back by a player.

In one aspect, a method for providing video comprises selecting a video file; uploading the video file for processing; applying an ID to the second file; extracting a plurality of still images from the video file; storing each extracted image file to creating N image files, creating a header for the second file indicating video technical data including FPS, storing first still image data in a second file, calculating delta change information compared with next still image, appending the delta change information to the second file. The second file may be marked-up using one of: HTML5 and interactive links.

In one aspect, a computer-implemented method for providing secure, high quality video and media via HTML5 without the need for a video player plug-in upon a product purchase selection, wherein the product purchase at a first web site may be facilitated by a unique identifier of the publisher associated with at least one second link, wherein the providing, the sending, the receiving and the facilitating step are performed by a computer.

In one aspect, a system is provided comprising a least one server configured to: extract a plurality of still images from a video file, construct a second file comprising at least one extracted image obtained from the plurality of still images, compute delta change information between the at least one extracted image and a second extracted still image of the plurality of still images, and appending the delta change information to the second file, wherein the second file is playable to reproduce the video file by presenting a series of images reconstructed using the second file and the delta change information. The at least one server may be configured to compute multiple delta change information between a plurality of still images and a plurality of second still images and appending the multiple delta change information to the second file. The second file may be played back using the plurality of still images and multiple delta change information. The second file may be marked-up using HTML5 and/or interactive links. The second file may be embedded or linked-to in a website for playback. The second file may be secured using encryption techniques that selectively or conditionally prevent partial or total access, use or playback depending on predefined parameters controlled by DRM configurations. The playing of the second file does not require the use of plugins or standard video players at an end user device. The second file may be created based on the frames per second of the video file. Moreover, the second file may be created based on an intended target device display size so that reproduced video from the second file is reproduced according to the technical capability of the target device.

In one aspect, a method for providing video, the steps comprising selecting a video file, uploading thevideo file for processing, generating an ID for a second file, applying the ID to the second file, extracting a plurality of still images from the video file, storing each extracted image file to creating N image files, creating a header for the second file indicating video technical data including FPS, storing first still image data in second file, calculating delta change information compared with next still image, appending the delta change information to the second file. The method may include processing all of the plurality of images files and calculating a plurality of delta change information for the plurality of image files and appending the plurality of delta change information to the second file. The second file that includes at least the first still image and the plurality of calculated delta change information is configured to be played to reproduce the video by using the at least first still image and the plurality of calculated delta change information. The second file may include multiple still images. The second file may be created based on the intended target device and a display size associated with the device. The second file may be marked-up using HTML5 and/or interactive links. The second file does not require additional plug-ins or standard video players to be played. The second file may be protected using DRM techniques or additional secure techniques to prevent unauthorized access or access may be conditionally provided based on authorization and/or payment.

In one aspect, a computer program product embodied on a non-transitory computer-readable medium for creating a video that when read and executed by a computer processor causes execution of the following extracting a plurality of video frames from a video file containing a video, creating a second file comprising: a header conveying a speed of the video, the plurality of extracted video frames, wherein the extracted video frames are marked-up. The extracted video frames may be marked-up using HTML5. One or more images or objects within the plurality of video frames may be hotlinked and selection of the one or more images or objects causes redirection to a website during playback.

In one aspect, a computer program product embodied on a non-transitory computer-readable medium for creating a video that when read and executed by a computer processor causes execution of the following: extracting a plurality of video frames from a video file containing a video, computing a delta change information between at least one extracted video frame and a next extracted video frame, creating a second file comprising: a header conveying a speed of the video, the delta change information for each extracted video frame and each next extracted video frame; wherein the extracted video frames are marked-up, wherein the second file is configured to be played-back by a player. The extracted video frames may be marked-up using HTML5. One or more images or objects within the plurality of video frames may be hotlinked and selection of the one or more images or objects causes redirection to a website during playback.

### BRIEF DESCRIPTION OF THE DRAWINGS

The accompanying drawings which are included to provide a further understanding of the disclosure are incorporated in and form a part of this specification, illustrate examples of the disclosure and, together with the detailed description, serve to explain the principles of the disclosure. No attempt is made to show structural details of the disclosure in more detail than may be necessary for a fundamental understanding of the disclosure and the various ways in which it may be practiced. In the drawings:

FIG. 1 is an example of a computing system, configured according to principles of the disclosure;

FIG. 2 is a flow diagram of an example process, the steps performed according to principles of the disclosure;

FIG. 3 is a flow diagram of an optional sub-process, the steps performed according to principles of the disclosure;

FIG. 4 is an example of a process for using a BrowsePlay file, the steps performed according to principles of the disclosure;

FIG. 5 is an example of a functional block diagram of an example system configured according to principles of the disclosure showing example steps of functional interactions according to principles of the disclosure;

FIG. 6 is an example of a functional block diagram of an example system configured according to principles of the disclosure showing steps performed according to principles of the disclosure;

FIG. 7 is an example of a process to embed hotlinks into a video stream, the steps performed according to principles of the disclosure;

FIG. 8A is an example of a display showing a video with multiple object images therein, configured according to principles of the disclosure;

FIG. 8B is an example of a display showing a video with an enlarged portion of the video of FIG. 8A, configured according to principles of the disclosure;

FIG. 9 is an example of a BrowsePlay video file, configured according to principles of the disclosure;

FIG. 10 is an example of a process to mark-up or hotlink a video, the steps performed according to principles of the disclosure; and

FIG. 11 is an example of a process for playing back a BrowsePlay video, performed according to principles of the disclosure.

### DESCRIPTION OF THE DISCLOSURE

The disclosure and the various features and advantageous details thereof are explained more fully with reference to the non-limiting examples that are described and/or illustrated in the accompanying drawings and detailed in the following description. It should be noted that the features illustrated in the drawings are not necessarily drawn to scale, and features of one example may be employed with other examples as the skilled artisan would recognize, even if not explicitly stated herein. Descriptions of well-known components and processing techniques may be omitted so as to not unnecessarily obscure the principles of the disclosure. The examples used herein are intended merely to facilitate an understanding of ways in which the disclosure may be practiced and to further enable those of skill in the art to practice the features and capabilities of the disclosure. Accordingly, the examples herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include a computing device, for example, but is not limited to, a mobile telephone, a personal data assistant (PDA), a mobile computer, a stationary computer, a smart phone, mobile station, user equipment, or the like.

A “server”, as used in this disclosure, means any combination of software and hardware (a computer platform), including at least one application and at least one computer processor to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like. Online refers to and includes activity on a network by connected users of the network. A “communication link”, as used in this disclosure, means a wired and/or wireless medium that conveys data or information between at least two points. The wired or wireless medium may include, for example, a metallic conductor link, a radio frequency (RF) communication link, an infrared (IR) communication link, an optical communication link, or the like, without limitation. The RF communication link may include, for example, WiFi, WiMAX, IEEE 802.11, DECT, OG, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise. The terms “first” and “second” such as appearing in the claims do not necessarily convey order or a count, and may be used as an adjective to distinguish a term from another of the same term.

Devices that are in communication with each other need not be in continuous communication with each other, unless expressly specified otherwise. In addition, devices that are in communication with each other may communicate directly or indirectly through one or more intermediaries. Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-transitory media or storage, non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes or altered make-up, a RAM, a PROM, an EPROM, a FLASHEEPROM, any other memory chip or cartridge, or any other tangible medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, OG, 1G, 2G, 3G or 4G cellular standards, Bluetooth, or the like.

The system and method of the present disclosure, generally known as BrowsePlay (“BP”), provide multiple benefits and new capabilities for managing and distributing video content. Video is a basic element of digital content that is growing in importance as Internet bandwidth improves. As a consequence, digital related companies are now becoming content producers and distributors.

In one aspect, BrowsePlay may be particularly advantageous as it relates to mobile web (but not limited to mobile web). Mobile web refers to access to the world wide web, i.e., the use of browser-based Internet services, from a handheld mobile device, such as, e.g., a smartphone or a feature phone, connected to a mobile network or other wireless network.

BrowsePlay solves several problems that currently exist including allowing for simple markup and managing of video content like images in HTML on a computing device such as, e.g., mobile/tablet devices, personal computers, cellphones and the like. For users who want the ease and simplicity of a browser-based video playback solution and for content owners and distributors who might need the protection of a secure DRM platform, BrowsePlay may provide a cross-browser, cross-device, and secure solution that can be tracked in a variety of ways. BrowsePlay is currently a HTML5 based (but is contemplated to be supported by future versions of HTML) secure, cross platform, fully interactive video solution, that offers web designers a large number of options for creatively choosing in how the video is presented as needed in the marketplace.

BrowsePlay provides a system and method for delivering secure digital video in a computing device such as, e.g., a mobile device or tablet browser-based environment without the need for a proprietary video player. Rather than playback content using a required plugin such as, e.g., Flash™ or Silverlight™, video may be rendered into a HTML <img> tag using a data URI (uniform resource identifier) in the format of, e.g., a base 64 encoded .png (portable network graphics) or similar format and the audio may be played directly from an audio buffer. A plug-in would not necessarily be required. Plug-ins for video playing may be eliminated.

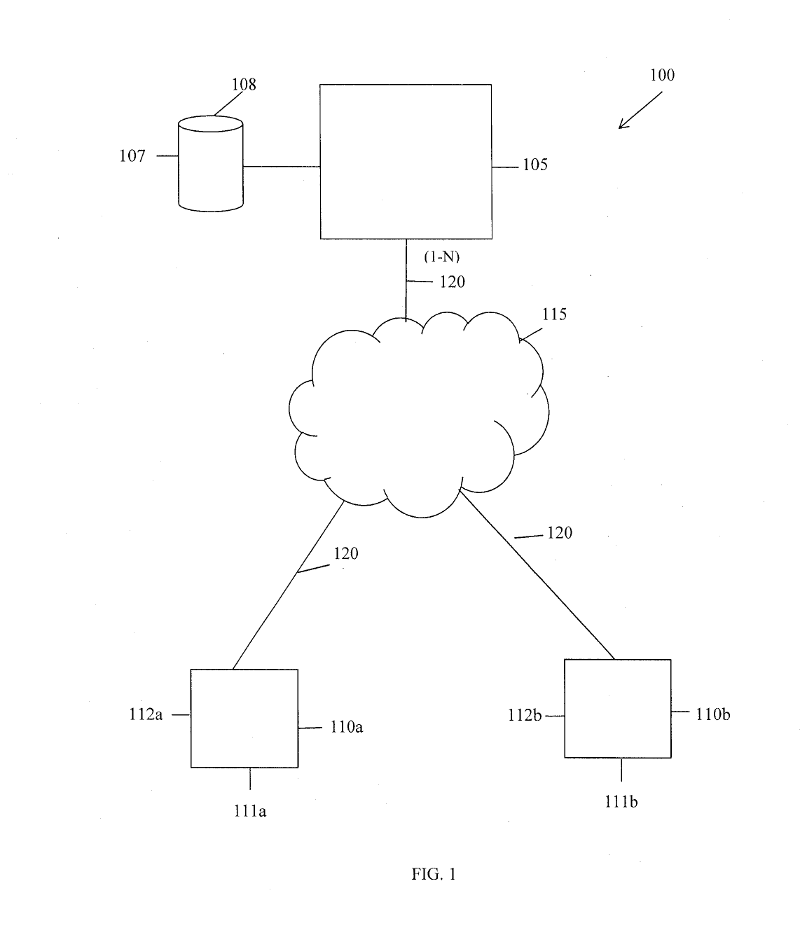

FIG. 1 is an example of a computing system, configured according to principles of the disclosure, generally denoted by reference numeral 100. The computing system 100 may include one or more Content Management Servers (CMS) servers 105 in communication with user devices 110a, 110b via one or more communication links 120 which may include a network 115. The network 115 may include the Internet. The server may be in communication with a database 107, which may store one or more files 108 such as video files, image files and/or BrowsePlay files as described more fully herein. The database 107 may be distributed. The user devices 110a, 110b may comprise a computing device such as a mobile device, a tablet computer, a personal computer a cellphone and the like. The computing system 100 is a simple architecture sufficient to give examples of the principles of the disclosure, but more complex architectures may be utilized as one of ordinary skill in the art would recognize.

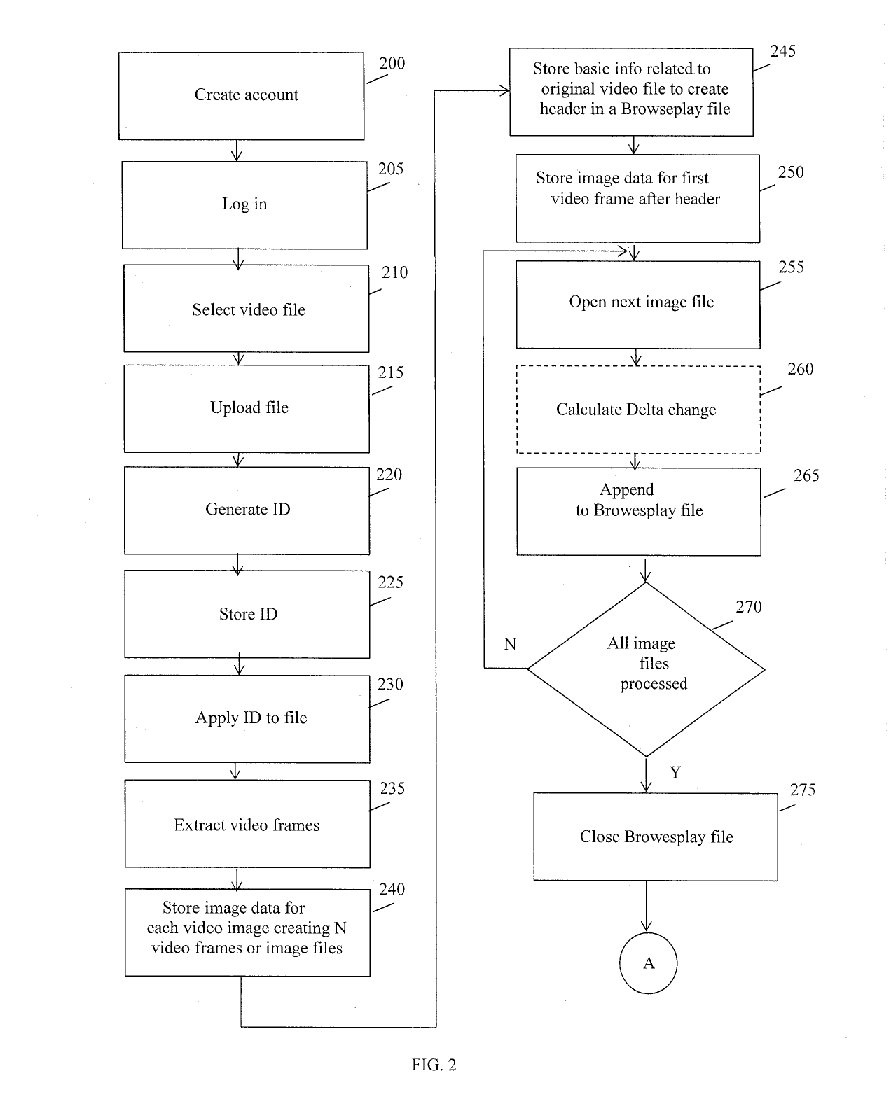

FIG. 2 is a flow diagram of an example process, the steps performed according to principles of the disclosure. The process of FIG. 2 (and the other flow diagrams herein) may be performed in conjunction with the system of FIG. 1, 5 or 6. FIG. 2 (and all other flow diagrams or processes herein) may also represent a block diagram of the software components configured to perform the respective steps. The software components in conjunction with appropriate computing hardware that includes a computer processor may execute logic to accomplish the respective steps. The software components may also be embodied on a non-transitory computer-readable medium that, when read and executed by a computer processor, performs the respective step. The software components embodied on a non-transitory computer-readable medium may comprise a computer program product.

At step 200, a user of BrowsePlay may create an account with BrowsePlay, the creation process for which may be controlled and performed, e.g., by the Content Management Servers (CMS) server 105. The user may have a video file which may include audio that they may want to include into a website. If the user already has a BrowsePlay account, the user may begin with step 205. At step 205, the user may login to a secure BrowsePlay website account, which may require appropriate validation such as entering a password and/or responding to a challenge. At step 210, the user may select a video file for uploading to BrowsePlay. The selection and/or uploading may be facilitated by one or more menu options or dialog boxes presented to the user for selecting a file, controlling and initiating the upload of the video file. At step 215, the selected video file may be uploaded to the BrowsePlay CMS server, such as server 105. The file may be stored on, e.g., database 107. At step 220, the CMS server may generate an Identifier (ID) for the BrowsePlay video file 108, such as creating a random ID, which may be stored in the database 107. The database 107 may be a secured database/file system, such as being encrypted. At step 230, the BrowsePlay CMS server may change the name of the uploaded video file to the assigned ID. Alternatively, the video file may be stored initially with the random ID as the file name, and/or as part of the file name.

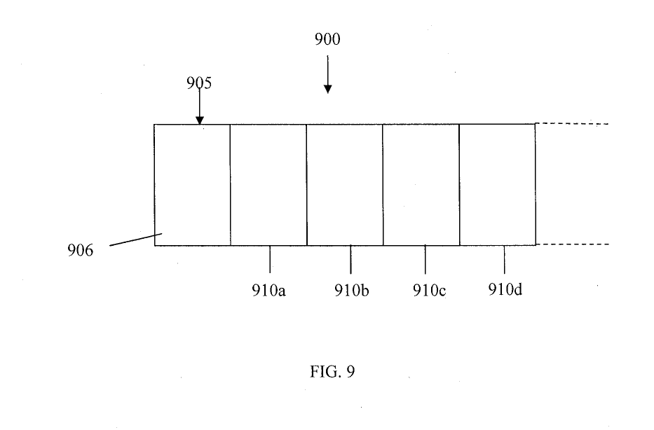

At step 235, the CMS server may open the uploaded video file and may extract all of the video image frames from the video file. At step 240, the extracted video image frames may be stored as N separate image files inside a directory, e.g. in database 107, which may also be named using the generated ID from step 220, at least in part; perhaps with a frame count appended. The total number of extracted video image frames may vary depending on the video content, and may be equal to the frames per second of the uploaded video file multiplied by the duration of the video files in seconds. At step 245, a BrowsePlay file (see FIG. 9 for an example) may be created. The BrowsePlay file may include a portion, referred to as a header, which specifies the basic information about the original uploaded video file, such as, e.g., frames per second of the original video, type of encoding and/or audio information. At step 250, the server 105 may open the first extracted video frame (which was stored in step 240) and may store this video frame's data after the header portion in the BrowsePlay file. At step 255, the next video frame may be opened. Optionally, at step 260, a calculation may be performed to calculates which parts of the video frame from the prior frame needs to change to produce the next frame (analogous to dirty region redraw). This delta change information related to which parts or regions are changing may be appended to the BrowsePlay file (at step 265). This type of video compression may significantly reduce the amount of video data that will eventually have to be transmitted or streamed. Typically, delta change information is used for an entire video file, if and when elected to be used. At step 265, either the video frame (from step 255) and or the delta change information (from step 260), as appropriate (one or the other), may be appended to the BrowsePlay file. (When playing-back a BrowsePlay file, the delta change information if present may be recognized by a BrowsePlay player and processed accordingly to reproduce a video stream).

At step 270, a check may be made to determine if all of the separate image files have been opened an appended to the BrowsePlay video file. If not, then the process may continue with step 255. Otherwise, if all image frames have been opened and the data appended, at step 270, the BrowsePlay file may be closed. At optional step 280, the BrowsePlay file may be transferred as appropriate to a secure file system that is accessible or works with a content delivery network.

At step 285, (alternatively, this step may be among the first steps of the process) the original video file uploaded from a user may be transcoded into other video resolutions so the video may be suitable for various screen dimensions such as those found on device display screens such as cellphones, tablets, mobile devices, and the like. At step 290, the process and relevant steps (e.g., 205-280, or a subset thereof as appropriate) above may be repeated to produce other BrowsePlay files having different video transcoding for different screen formats, as needed for differing device applications. Optionally, additional BrowsePlay files may be created by transcoding the extracted video frames into different image formats, which may have advantages over the original video frame format when used on different devices. For example, the video frames may be transcoded into WebP format, which is smaller than a widely supported format like JPEG, but is only natively supported in certain web browsers, such as Google Chrome™. The video frames may be transcoded into any number of different formats and into any number of different resolutions, allowing the BrowsePlay system to deliver to the end user the best possible viewing experience of BrowsePlay content for their devices by automatically choosing the most ideal format and resolution for that device.

The BrowsePlay files produced by the process of FIG. 2 may be embedded into websites so that video can be delivered to a wide range of user devices as described more below.

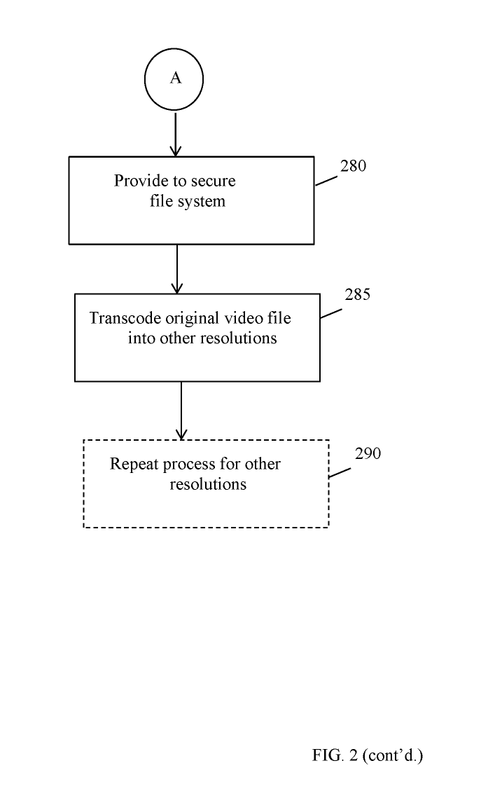

FIG. 3 is a flow diagram of a sub-process, the steps performed according to principles of the disclosure. The process of FIG. 3 may be optionally used in addition to the steps of FIG. 2 to further protect and secure the video that has been converted to a BrowsePlay file. At step 300, each image video frame (such as, e.g., at step 235), may be split into a plurality of parts, such as a grid of squares analogous to a checkerboard. Alternatively, the image frames may be separated by color channel. At step 305, the parts may be stored in the BrowsePlay file (e.g., along with step 240). At step 310, when the BrowsePlay file is eventually played, the separate parts are recombined in time sequentially to display the full video. This may simulate the original video. The process of FIG. 3 promotes added security of the video, since the actual portioning and recombining of the parts add another level of security so that unauthorized use of the BrowsePlay file may be prevented. The exact sequence and portions of the image frames can change over time to improve security. Moreover, the actual sequencing technique can change dynamically over time.

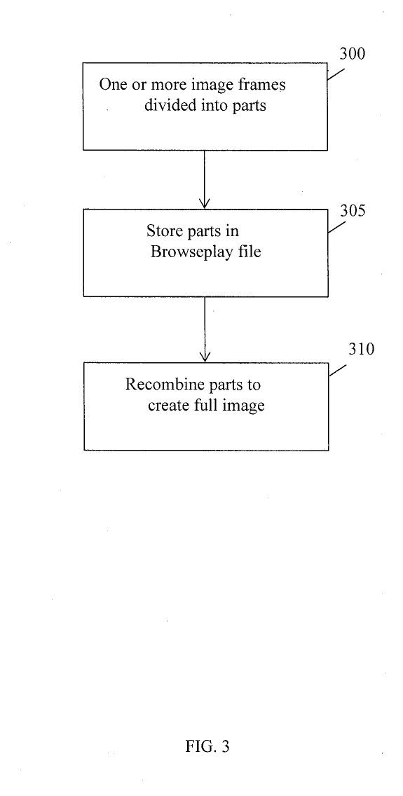

FIG. 4 is an example of a process for using a BrowsePlay file, the steps performed according to principles of the disclosure. At step 400, a user may select a BrowsePlay file (such as produced by the process of FIG. 2) for inclusion or accessibility with other content such as, e.g., a website. At step 405, the user may be given access to HTML embed code which they can play on at their website. At step 410, additional security may be employed to prevent actual playing of the BrowsePlay file. The user who chooses to utilize the BrowsePlay file may be free to style their own website using the embedded player for playing the video using standard technologies like cascading style sheets (CSS). At step 415, access for others, such as consumers, to the website and BrowsePlay file may be initiated.

When a website creator wants to include a BrowsePlay file, such as in the process of FIG. 4, the website creator may need to have a special token that is associated with that BrowsePlay file. By default, each video uploaded to BrowsePlay has one token assigned, which may be the random ID generated in 220.

When the website user embeds the BrowsePlay file (e.g., file 900 in FIG. 9) in their website(s), the embedded URL may contain this token, and the website creator does not need to know the token in order to play the video content from the BrowsePlay file. If the website creator chooses, the BrowsePlay content can be protected so that playback is only possible with an additional secure token. Any number of these secure tokens can be generated, and special rules can be attached to the tokens. These rules may include a limit on the number of times an item of content can be played with each token, region locking, or other limitations, such as., e.g., whether or not the content can be passed to another user or consumer or whether payment might be required.

Playback

When an end user accesses a website (such as created by a website creator) that has an embedded or included a BrowsePlay video (e.g., file 900), the end user's browser 111a, 111b may receive javascript code from BrowsePlay's server(s) such as, e.g., Content Management Servers (CMS) server 105. This code may include, but not limited to, html, css and javascript. Once the browser has received this code, it may include an <img> tag which browsers may use to display images. Optionally, the browser may then download a single image file from the ContentManagement Servers (CMS) 105 (or sever 520), and display this image on the website using the <img> tag. The browser may then open a connection with server 105, and using this connection, may send the server 105 identifying information such as the size of the browser's window, the type and version of the user's device, and the type and version of the browser itself If an additional access token is required to access the video, the browser may wait to open this connection until the token is provided by the end user or through some other means. Once the token is provided, the connection may be opened and the identifying information as well as the token may be sent. The server 105 may proceed to determine the appropriate BrowsePlay file for the particular end user's device and screen size. The server 105 may then respond with an URL which the browser may use to download the appropriate BrowsePlay file.

The browser 111a, 111b may then begin downloading the BrowsePlay file. As the bytes of the BrowsePlay file are received by the browser, the javascript code may be configured to attempt to interpret the data contained in these bytes, even before the entire file has been downloaded. The javascript code may attempt to begin rendering the BrowsePlay video using only part of the complete file in order to reduce the amount of time the end user has to wait before the video can begin playing. To do this, the javascript code may include a function which scans through the downloaded bytes searching for complete video frames. As the browser receives more bytes, the javascript function may find more complete video frames. Each complete video frame that is found may be placed into an array in the browser's memory by the javascript code. This array is used as a “buffer.” The browser may then try to determine if there are enough video frames in the buffer to facilitate smooth video playback. This determination may be made by comparing the total number of frames in the video with the rate at which complete video frames are being added to the buffer. Once the javascript code has determined that smooth playback is possible, the javascript code may begin rendering the video. First, the javascript code will take the first video frame in the buffer and display it in the <img> tag created earlier by the browser. Then, the javascript code will advance to each subsequent video frame in the buffer, and after a delay, display it in the <img> tag. The javascript code can calculate this delay by dividing the number of milliseconds in one second (1000) by the frames per second (FPS) of the video.

The javascript code downloads a still image frame (i.e., a video frame) from the Content Management Servers (CMS) server 105 and database 107 that is the first frame of the original video. This image may be loaded into an <img> tag and displayed to the end user. A web socket connection (a special type of HTTP connection which remains open between the browser 111a, 111b) is opened to a server 105. Once the web socket connection is opened, the user's browser 111a, 111b may send the server 105 identifying information such as the size of the browser's window and what type of device (e.g., model and/or software versions) the end user or consumer is actually using. If an additional access token is required to access the video, the browser 111a, 111b may wait to send this information until the end user provides a token. Once the token is provided, the information (including the token) may be sent. The server 105 may proceed to determine the appropriate BrowsePlay file for the particular user/consumer's device and screen size. The server 105 may begin sending to the browser 111a, 111b the data contained in the BrowsePlay file over the web socket connection.

At the browser 111a, 111b, the header is received. From this header, the javascript code is configured to read information related to the video file such as the frames per second (FPS) of the original video. Next, the browser 111a, 111b may receive the delta change image data that was calculated at step 260. Once the first full image frame has been received, the javascript code is configured to display this image data on the screen using one or more HTML <canvas> or <img> elements. The element(s) are placed behind the static image from Step 2. If more than one element is used, it may be used to support the security measures described previously, such as in reference to FIG. 4.

Once the first image frame is on the user's display screen 112a, 112b, the still image frame may be removed from view, and playback may begin. The javascript may use the FPS as read from the header and the rate at which it is receiving image data over the web socket connection to determine whether smooth playback at the desired FPS is possible. If smooth playback is determined to be possible, the javascript will rapidly change the image data on screen using the calculated differences in frames (as calculated at from step 260). In practice, the javascript may only change the parts of the image data on screen that is necessary to create the next frame of video. If the video sequence cuts from one shot to a completely different one, all or nearly all of the image data on screen would need to change to produce the next complete frame. The less parts of a video change from one frame to the next, the less data will be needed for that section of video. If smooth playback is not possible, the javascript will wait until more data has been received, and resume playback. During this waiting period, a ‘loading” indicator may be displayed to the end user.

Another Example of How Video Content May Be Served to Clients:

To start playback of a piece of content, a client (e.g., user device 110a, 110b) such as used by a consumer may need a valid token giving access to that content. Once a valid token is validated via a conditional access protocol, the content can be accessed by the client. A number of static images may be downloaded from a remote server such as server 105 to serve as the initial buffer for video playback. Simultaneously, a web socket connection may be opened to an application server such as server 105, or a separate server. The client device sends this application server a request to begin sending the content. Included in this request may be the content token as well as information about the client's capabilities (screen size, resolution, browser name/version, etc.). The server may choose from the available quality options to best fit the capabilities of the client. Upon determining the best fit, the server then opens this file, and starts sending the video and audio data (if present) to the client. As the client receives this data, it dynamically determines based on download speed and other factors whether enough data has been received to facilitate smooth playback. When enough data has been received, playback begins. Playback may be paused for buffering anytime the amount of unplayed video and audio data held by the client becomes too small for smooth playback to continue. When enough new data is received, playback resumes.

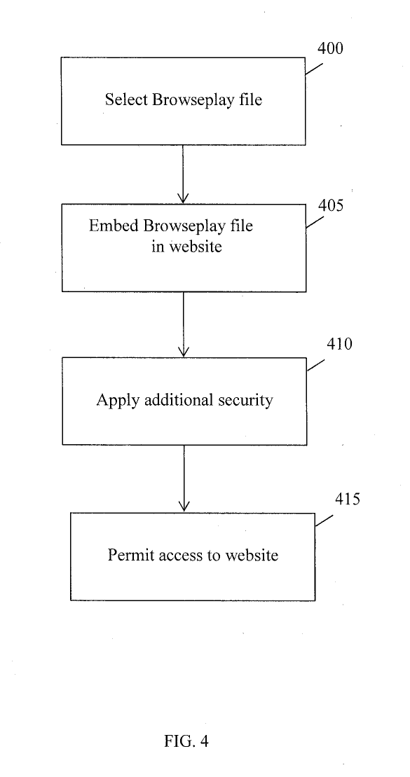

FIG. 5 is an example functional block diagram of an example system configured according to principles of the disclosure showing example steps of functional interactions. As shown in FIG. 5, the system and steps may include:
S500. An end user (the “user”) may use a computing device 502 (which may be devices 110a, 110b), which may be a mobile device or other computer based device, to access a web page 507 that incorporates one or more BrowsePlay players 508a.
S505. One or more BrowsePlay players 508a may be loaded to the computing device 502 of the user, providing a BrowsePlay player 508b on the computing device 502 to be used by the user.
S510. A web socket connection 513 (or other suitable connection) may be opened over a network, such as network 115 (FIG. 1), between computing device 502 of the user and a content server 510. The server 510 may send a message to the downloaded BrowsePlay player 508b advising the total amount of data to expect. This may indicate the size of the video and any audio data of the BrowsePlay file. This message may be received at the BrowsePlayplayer 508b.
S530. The server 520 (which could be server 105) may begin streaming the audio (if applicable) and video data to the BrowsePlay player 508b over the connection, such as the web socket connection 513. This streaming may be controlled by the user via, e.g., a play icon 511, displayed on the display 504 of the computing device 502. The BrowsePlay player 508b may stream the video, in accordance with the BrowsePlay format such as produced by the process of FIG. 2, and in accordance with parameters found in the header. The streamed video (and any audio) may be reproduced to the display of the computing device 502 so that the plurality of individual video frames of the BrowsePlay file created by the process of FIG. 2 appears to be a continuous video stream. Any embedded links and /or hot links may be displayed for activation by the user of the computing device 502. In this way, the video stream permits activation and of any tagged visual objects in the streamed video so that embedded links and /or hot links may result in activation while the video stream is being played.
S535. Buffering—based on the amount of data that is received over a window of time, the player 508b may calculate whether smooth playback can continue. If the total amount of data has not been received, but the local buffer of data is insufficient for smooth playback, the player may pause playback and display a loading indicator. Once enough additional data is received, playback may resume.

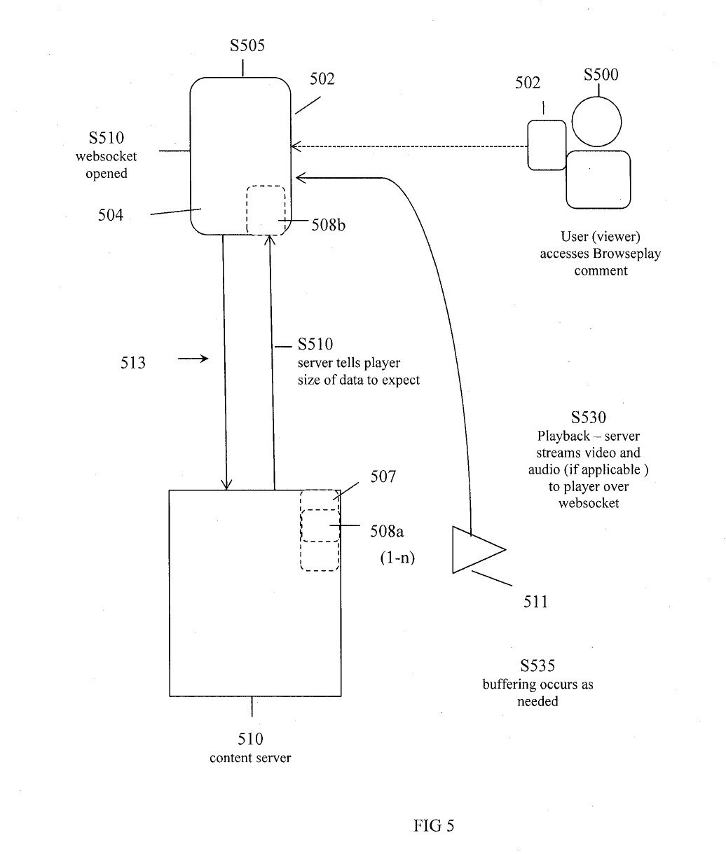

FIG. 6 is an example functional block diagram of an example system configured according to principles of the disclosure showing steps performed according to principles of the disclosure. As shown in FIG. 6, the system and steps may include:
600. A content owner (the “customer”) may use an Internet browser or mobile application to access BrowsePlay services, such as provided by servers 105, 510, or 650.
605. Using the application, the customer may upload a video file to BrowsePlay server 650.
610. When server 650 receives the video file, a new job may be created in a queue for processing.
615. A worker server (i.e., the same or different server) listens to this queue, and when the job is available, takes or receives the job from the queue and begins processing the job.
620. The image data contained in the video file is extracted into individual frames, which may be the same as described in the process of FIG. 2.
625. The image data contained in each of these frames may be base64 encoded (e.g., using JavaScript Object Notation) and stored.
630. The audio data contained in the video file may be extracted and stored.
635. If the customer has enabled obfuscation, the system may select from a set of possible obfuscation methods, further manipulates the extracted audio (if present) and video data based on this method, and then stores a key representing how to reassemble the data. In addition, if additional encryption security is desired, the WC3 standard for EME (encrypted media extensions) could also be layered in as a further security measure using any number of security implementation methods.
640. The customer is notified that their uploaded video is ready for use, such as for dissemination and/or sale.

In one embodiment, a BrowsePlay file 900 may be sent to a computing device (e.g., device 502) in its entirety for playback on the computing device. Once received by the computing device the file 900 may be stored locally for playback. The BrowsePlay file 900 may be played-back locally on the computing device in accordance with parameters in the header 905.

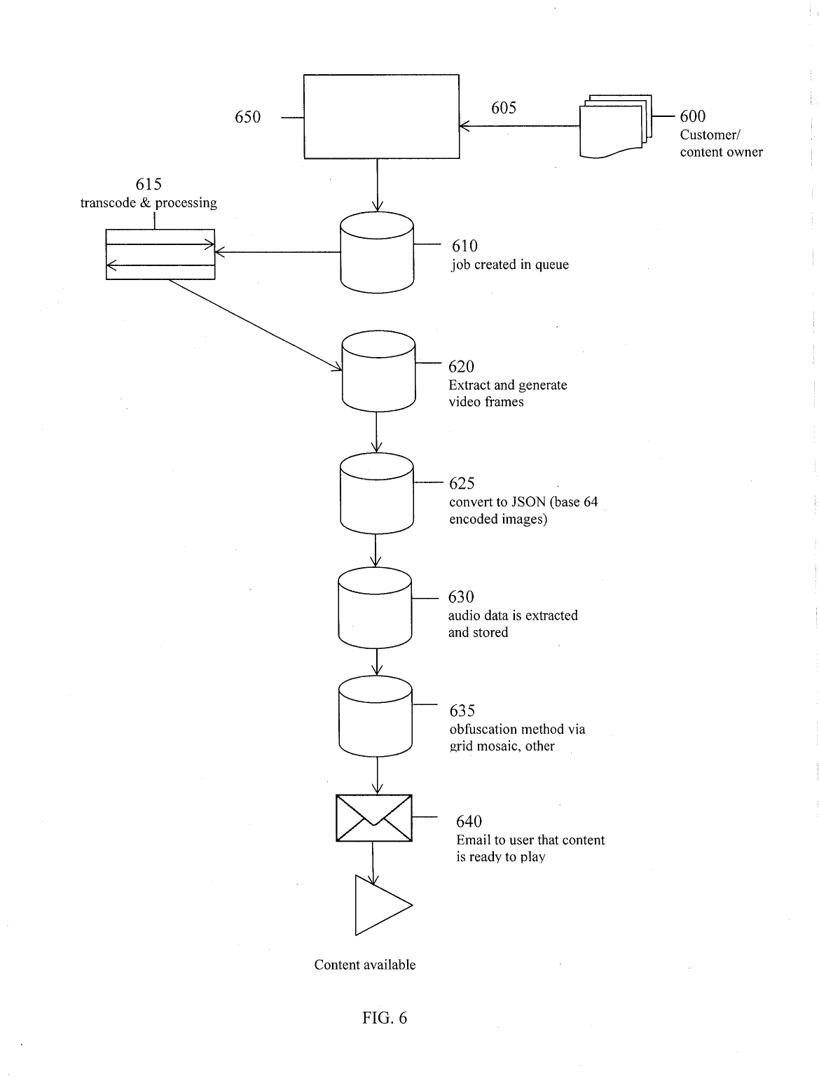

FIG. 7 is an example of a process to embed hotlinks into a video stream, the steps performed according to principles of the disclosure. Certain of the steps of FIG. 7 may be optional and not necessarily required. However, these steps of FIG. 7 may provide significant feature capability based on the advantageous technique of managing the video frames of a BrowsePlay file. Moreover, steps 700-710 may be included during the process of FIG. 2, or these steps may be performed separately from the process of FIG. 2. That is, as the BrowsePlay file is being created during FIG. 2, one or more objects within a video may be hotlinked. Alternatively, the hotlinking may be a post BrowsePlay file creation activity wherein one or more of the video frames may be hotlinked.

At step 700, the video may be read and at step 705 one or more objects or portions within the video may be identified to be hotlinked. At step 710, one or more video frames may be hotlinked to establish a connection to a website or other network destination. The hotlinked frame(s) may be stored. The hotlink may be associated by a user or automatic program with a particular object or image portion in the video, e.g. the object may comprise a ball, device, person, image, natural feature, select portion of the video frame(s), etc., so that when a user subsequently selects the object during the playback phase, the hotlink may be executed and processed to redirect to the predefined destination or website. The hotlink may be activatable by a user during all frames of the video. Alternatively, the hotlink may be activatable during a select range (or subset) of the frames of video, which may be determined during the hotlinking process. Moreover, a plurality of distinct objects (as defined by a user or an automated program) in the video may be hotlinked so that there are multiple different hotlink destinations for a plurality of objects in the video. The hotlinks may be defined to remain associated with a particular respective object across multiple video frames. As a non-limiting example, a golf club appearing in a video may be hotlinked to a website of manufacturer or distributor of that golf club where more information or another video may be presented. Any number of objects in the video may be hotlinked and directed to a respective predetermined destination. The video frames may be marked up using a markup language such as, e.g. HTML5.

At step 715, which may be performed during playback of a BrowsePlay video, a user may select an object such as by clicking on the object in the streaming video, and if the selected object is hotlinked, the hotlink is processed and the destination associated with the hotlink may be resolved and displayed to the user on the user's device, such as device 502, 111a, 111b.

At step 720, during playback of a BrowsePlay video, a user may elect to “zoom” into a portion of the video picture. When selected, or requested by a user, an enlarged image is displayed related to the selected portion.

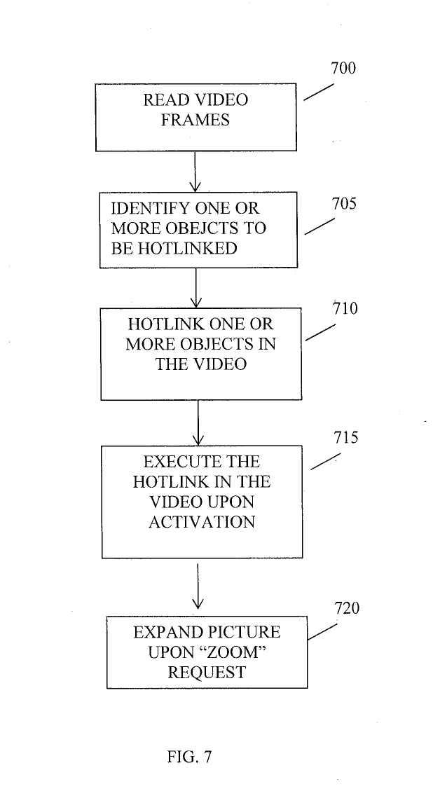

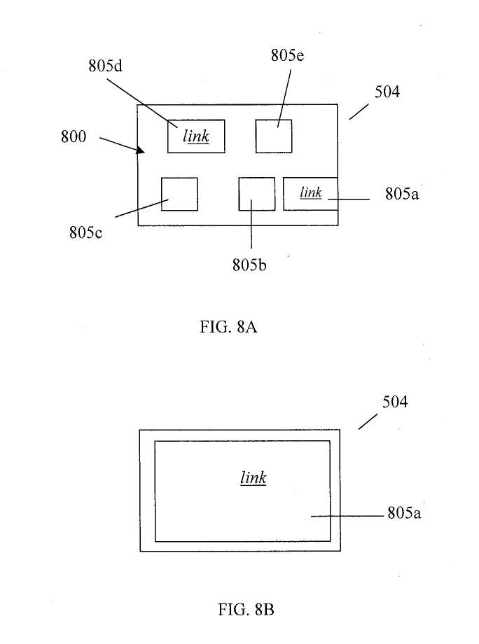

FIG. 8A is an example of a display showing a video with multiple object images therein, configured according to principles of the disclosure. FIG. 8B is an example of a display showing a video with an enlarged portion of the video of FIG. 8A, configured according to principles of the disclosure. As shown in relation to FIGS. 8A and 8B, a display 504 may be displaying multiple objects 805a-805e during playback and streaming of a BrowsePlay video 800 that was produced, e.g., by the process of FIG. 2. The displayed 504 may include one or more hotlinks (labeled as “link” in FIGS. 8A and 8B) as shown. The hotlinks (“link”) may be positioned at any location(s) in the display 504, and may be activated when selected by a user. In this way streamed video may contain links to other destinations for added content to be dynamically displayed during streaming, which may be related to an object in the video.

The BrowsePlay video 800 may include a plurality of objects 805a-805e that may be images of any object, concept or scene. If a user elects to “zoom” one of these images, or a portion of the image 800, the user may use device controls such as, e.g., a cursor or mouse, to select and enlarge “zoom” the desired portion of the image 800. As shown in relation to FIG. 8B, the user elected to enlarge the image area generally associated with object 805a. Any image 800 area, or any portion of the image, might be selected and “zoomed.” The selected area, in this example, portion 805a, has been enlarged. Because the BrowsePlay video comprises multiple individual frames, as each frame is displayed in turn, the equivalent or corresponding selected portion (e.g., the area associated with 805a) of each subsequent individual video frame may be enlarged accordingly to continue the streaming of the video with the selected portion, e.g., 805a, of the BrowsePlay video enlarged. In this way, portions of streaming video may be “zoomed” and the selected portion remaining enlarged across multiple frames to provide an enlarged or “zoomed” effect of a portion of a video that remains consistent while the video plays during the enlarged or “zoomed” mode. The zoomed video image may continue playback at the predetermined rate associated with the video frames but at the enlarged or “zoomed” mode.

A user may select any portion of the BrowsePlay video to enlarge. Moreover, any hotlink shown as “link” defined in the enlarged video portion (e.g., 805a in this example) may remain activatable by a user.

In some embodiments, hotlinks may be defined to be activateble only during an enlarged or “zoomed” mode. In some embodiments, some hotlink(s) may be defined to be activatable only during an enlarged or “zoomed” mode while other hotlinks may remain activatable (either in enlarged mode or in normal mode, or both modes). In either mode, the video content may be streamed consistently by displaying the BrowsePlay video frames at the proper or defined rate.

FIG. 9 is an example of a BrowsePlay video file, configured according to principles of the disclosure. The BrowsePlay video file 900 may comprise a header 905 that defines one or more parameters 906 of the BrowsePlay video contained in the file 900, a plurality of video frames (and any audio) 910a-910d such as produced, e.g., by the process of FIG. 2. The total number of frames 910 may be any number of frames, and may depend at least in part on the size of the original video file. The header 905 and the video frames 910a-910d may be read by a BrowsePlay player, e.g., player 508b, and processed and displayed on a display such as display 504 to reproduce the video in a streaming fashion according to the parameters contained in the header 905. The parameters may include information such as the frames per second (FPS) of the original video, codec information, size of the file, audio information, and possibly security information.

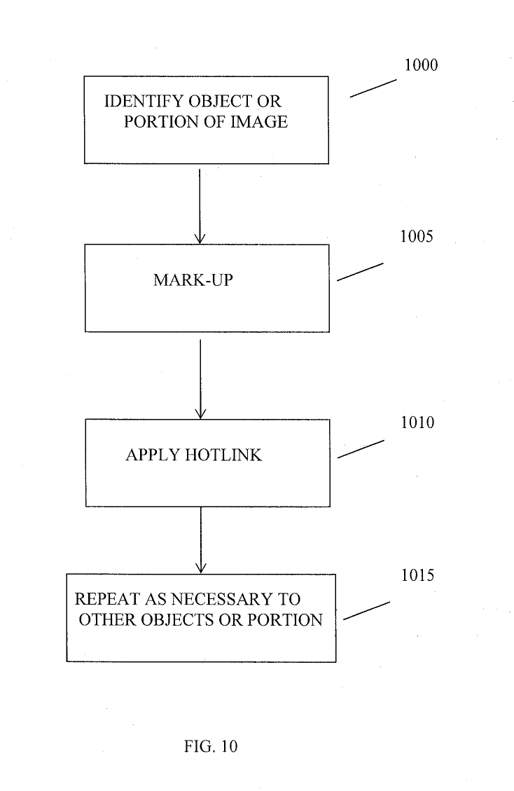

FIG. 10 is an example of a process to mark-up or hotlink a video, the steps performed according to principles of the disclosure. The process of FIG. 10 may be used in conjunction with the process of FIG. 2. That is, the video frames comprising a BrowsePlay video may be marked-up or hotlinked as the BrowsePlay file is being created (such as during the process of FIG. 2), or may be a separate process from FIG. 2. At step 1000, a user or automation program may identify an object or portion of an image that should be marked-up or hotlinked. Different objects or portions of an image may be mark-up differently or hotlinked differently, as deemed necessary. At step 1005, the video frames may be marked-up as deemed necessary by a user or automatic program. At step 101, the object or portion of an image of the plurality of video frames may be hotlinked as deemed necessary. At step 1015, a decision may be made as to whether or not other objects or portions of an image should be hotlinked or marked-up. If so, this process may be repeated to hotlink or mark-up other portions or objects.

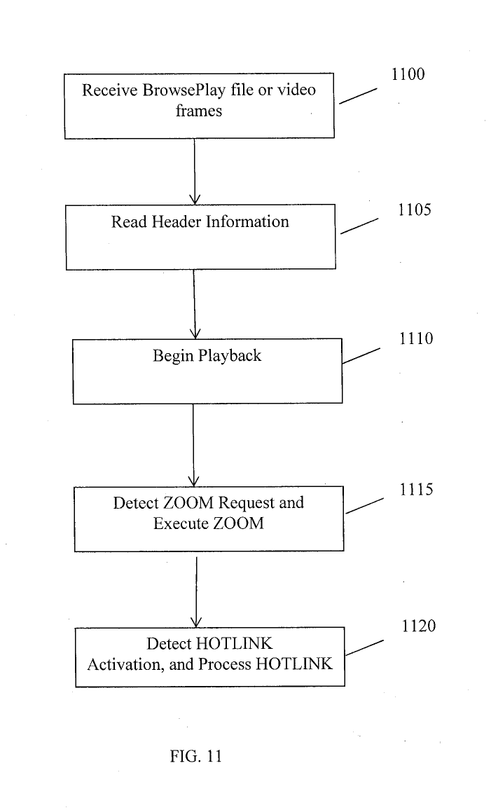

FIG. 11 is an example of a process for playing-back a BrowsePlay video, performed according to principles of the disclosure. A player (e.g., player 508b) at a computing device (e.g., device 502) may receive a BrowsePlay file or receive a portion of a BrowsePlay file. For example, a user may have accessed a website containing a BrowsePlay file (e.g., file 900) containing a video (and possibly audio) that has been previously created (e.g., by the process of FIG. 2). At step 1105, the player may receive the header (e.g., header 905) to ascertain parameters 906 associated with the BrowsePlay file such as, e.g., a speed of the video, type of frames, and/or size of the BrowsePlay file. At step 1110, the player may begin playback of the individual video frames (e.g., frames 910a-910d, or more) received in sequence at the proper speed to reproduce the original video. If the Browseplay file contains delta-change data (which may have been previously created by step 260 of FIG. 2), the player may reconstruct the video content for a given video frame to recreate necessary image data for that given frame. The playback may be controlled by a user. The player may playback the received video frames at the proper speed (e.g., per the header) on a display (e.g., display 504) of computing device (e.g., device 502). The BrowsePlay file may have been created initially for a particular form factor to match requirements of the computing device (e.g., size and/or resolution of the display). At step 1115, the computing device may detect a request for a “zoom” operation. This “zoom” request may be processed so that a selected portion of the images being played-back by the player are displayed enlarged per the “zoom” request. The “zoom” enlargement may be maintained across multiple video frames in a consistent area as selected by the initial “zoom” request, and so that the “zoom” operation spans a plurality of video frames. The video images of the “zoom” request may be played-back at the same rate as the non-“zoom”ed frames. At step 1120, the computing device may detect a user action that causes a response by the computing device to display new information based on markup information associated with the BrowsePlay file while the video frames of the BrowsePlay file are being played-back. The video frames of the BrowsePlay file may be marked-up, as previously described above (e.g., step 1005 of FIG. 10). A response to a user action may be processed per the mark-up. This typically results in new information being displayed. For example, if a hotlink (see, FIGS. 8A and 8B) is contained in the BrowsePlay file (which may be associated with an object or portion of an image in the video, as described previously) a request to process the hotlink (e.g., a user action to select the hotlink) may result in activation of the hotlink. This may result in a redirection to a website or other destination. This may result in new information being displayed, while the video is being play-back. The new information (e.g., a website associated with the hotlink) may be displayed as part of or along with the image for the video being played-back. The new information may appear to a user to be layered on the playing video. The hotlink may be operational during a ZOOM mode, and may be selectable in the “zoomed” area.

Another Example of How the Video Content may be Played:

The client (e.g., user device 110a, 110b) may decompress and/or may decode the video and audio data it receives on the fly (e.g., in real-time). For the video data, playback may be achieved by rapidly changing the “src” attribute of an <img> tag or by updating the pixel data of an HTML5 <canvas> element. The frames per second (FPS) of the original video file determines how many times per second the image data must be changed for accurate playback. This change rate may be predetermined based on the FPS of the original video file. The interval at which the image data is updated on screen may be equal to 1 second divided by the FPS of the video. For example, if the FPS of the video is 30, the image data is updated approximately every 0.03333 seconds. If the client supports javascript audio buffers, the audio data may be played back using one or more audio buffers. If audio buffers are not used, playback is achievable through an HTML5 <audio> tag. Since the video and audio data are sent together from the application server 510 to the client device 502, there is typically enough of each for playback to remain in sync.

The positioning data necessary to reassemble each whole image frame may be sent separately from the video data and may be hashed using a universally unique identifier (UUID) generated by each playback client at the time playback is requested.

If during playback, a user activates an embedded hotlink or tag previously defined and applied to the video, which may be associated with a particular object in the video, the hot link or tag may be processed and new information displayed as a result of the processing of the hot link or tag. In this way, a video containing different object images, e.g., balls, sports equipment, cars, hats, people, fishing poles, medical devices, or any other type of object image, may have a hot link or tag associated with that particular object, which may permit a user to activate that hot link or tag to be directed to another web site or other image associated with that hot link or tag.

In one aspect, in order for the back-end, e.g., server 105, to release access to the video content, a token must be provided. When the end-user initially attempts to open the content file of the video, access to the file may be granted or denied. Such a process is described, e.g., in one or more patents U.S. Pat. No. 7,673,059, U.S. Pat. No. 8,396,933, U.S. Pat. No. 8,578,464, U.S. Pat. No. 6,389,541 and/or U.S. Pat. No. 8,402,558. In this process, token data may be gathered from the user's device and sent to the back-end. Software code on the server 105 may combine this data with data related to the encrypted content file (i.e., a BrowsePlay file), which may include the previously stored decryption and usage data, and creates a permission token. The permission token may be hashed and then sent to another external or third party server (or possibly within the same server), which verifies the token exists in an access database. If the token is deemed valid, the server sends the client a unique hash which allows access to the video content. This access hash is stored in a remote database along with a hashed copy of all browser data sent to the server, such as the browser's user agent and language.

The client then opens a web socket connection to the server 105 and sends the access hash. The server 105 verifies that the access hash is valid, and that the browser's data matches the stored copy for that access hash. If this data matches, the audio, video, positioning and metadata for the content may be delivered to the client via this connection, or other designated connection.

A secure video file distribution feature of BrowsePlay is not limited to only offering secure content files for sale. In one version, a Secure Distribution of promotion video or images of the interface of the Secure Distribution section may allow a publisher to create, edit and store lists of individuals who may be pre-approved to access the secure content files. This list may contain the mobile phone number or other type of address of the mobile device of the intended recipients. The Secure Distribution interface may provide a tool that automatically sends pre-formatted text or email messages that may contain a link to all of the members of any of the secure distribution lists. To finalize the formation of a secure distribution group, the publisher may use the group push tool to issue an invitation to join the secure distribution group to the addresses on the list. When a member of the group receives the invitation, the link included in the message may guide him to the content. The member may then be prompted to confirm membership in the group.

This confirmation process can be used to alert the BrowsePlay publisher that members of the group have or have not confirmed their membership by a certain date. In this manner, the publisher may be made aware of which members of the group may need to be reminded.

Operation of a dashboard and all DRM Digital rights management techniques may be implemented using one or more techniques described, e.g., in one or more patents U.S. Pat. No. 7,673,059, U.S. Pat. No. 8,396,933, U.S. Pat. No. 8,578,464, U.S. Pat. No. 6,389,541 and/or U.S. Pat. No. 8,402,558, which are incorporated by reference herein, so that digital content such as documents or media files are accessible only by an authorized user/customer, and/or when payment is received. For example, a BrowsePlay video may only be access when paid for or when permissions have been acquired to access the video.

BrowsePlay may have the following non-limiting exemplary attributes:
a. Cross platform, video player independent that works with all HTLM 5 compliant browsers.
b. Video is fully interactive, just like a web page. Elements or portions inside the video may be “hot spotted” or “hotlinked.” They are clickable and interactive.
c. Video may be a design element, just like an image can be a design element. It can serve as a backdrop to an entire page. It can be used in mosaics designs and multiple sources of video and be running simultaneously on the same page at the whim of the designer.
d. The video may automatically scale to any display form factor and looks the same on small screens like mobile as it does on very large screens. Titles and other graphic elements on top of the video may be fully interactive and may be clickable, as deemed appropriate by a designer.
e. The video may be fully “zoomable,” like a still image may be “zoomable” under selection and control of a user. Prior to this disclosure, videos have not been “zoomable.” High resolution video can be “pinch zoomed” by the user, giving the user the option to view certain parts of the scene in close-up. As video resolution continues to grow (e.g., 4k Ultrahigh-definition), extremely technical videos showing work models and moving systems can be used for learning and diagnostic purposes, giving the user the ability to study the moving components in close-up.
f. Because BrowsePlay may make the video screen and all its elements fully interactive just like a web page, discrete videos can be a web page and can be addressed with a URL. In this new type of web page, a videographer may use BrowsePlay to add some interactive elements like titles to the video and then may post the video straight to the web and/or to a mobile device. There is no need for traditional web page programming knowledge and/or embedding in existing web pages including, e.g., YouTube™, Vimeo™, and the like. The videographer does not need to worry or be concerned about form factor, whether it will be a mobile app, web, or TV usage, as the video automatically conforms to each. A URL for every video may also give it enhanced tracking and use data, which is often very valuable to the producer.
g. The marriage of IP to RF: Traditional cable TV still uses RF frequencies, and output a non-interactive screen. A person can watch it, but typically cannot interact with it. Web based video and TV has offered additional interactivity, not inside the video but outside of the frame. The long-time dream of truly interactive TV has for a long time been a dream. But now, BrowsePlay stands at the intersection of these disparate delivery technologies and provides a truly secure, interactive, cross platform, IP based video delivery system.
h. Conditional access: Drawing on digital right technologies, such as those provided, e.g., by DRM Technologies, Inc., BrowsePlay provides for and enables secure conditional access and tracking. This includes rights management based business models such as pay-to-view, subscriptions, user ID, and others. These functions are provided in some applications fully inside the browser, and in certain uses may use the WC3 Encrypted Media Extensions specification to access cloud-based technologies, such as those previously patented by DRM Technologies, LLC.
i. Conditional access enables designers to build, e.g., light-weight app environments. These app-like mobile sites do not require the download of apps by the users and take away the cost of developing and maintaining apps for multiple operating systems. Further, these light weight apps can be marketed using short message service (SMS), email or other one-to-one communications that can take the user to the app with just a click, versus being taken to an app store, needing to have an account, buy and/or download the app, worry about space on their mobile for the app, etc.
j. The architecture of BrowsePlay supports follow on applications and enhancements as bandwidth and processor speeds increase. New types of ecommerce, large interactive video displays with multiple mosaics screens and RF like TV viewing experiences are all fully interactive and cross platform.

Advanced Features:

Beyond DRM video playback, BrowsePlay may have a broader ability to be a transformative force in the very fabric of HTML5 and the web by freeing video as an element from the restrictions of the <video> tag. A web capacity may be provided where video can be displayed and manipulated as images currently can be manipulated, all while maintaining DRM security. BrowsePlay may enable a web where site backgrounds and major design elements may be rendered in video that can be marked up, written onto, and deep-linked to (i.e., using a hyperlink that links to a specific, generally searchable or indexed, piece of web content on a web site).

Video can now be used in similar fashion as images currently are used, to showcase and sell products online. Specific areas could be much more easily tagged and “hot-spotted” within videos using this technology. Particularly in the emerging area of mobile and tablet commerce, new methods to merchandise and showcase products are key and this invention opens up multiple new possibilities to develop.

Some Example Applications

The following are a few illustrative non-limiting examples of how BrowsePlay might be used in various types of applications:
a. A web designer may use a video as a full screen backdrop for a web page and places the text and interactive links on top of the video, for a dramatic impact that is not seen on the web prior to this disclosure.
b. A web page has a video as a full backdrop to the page and its showing a product in action. Certain parts of the product components may be clickable and may be interactive. If, for example, a car is in motion in the video, clicking the wheel could take the user to another video of a close-up of the wheel in action and the details of the braking system. Components of the braking system can be clicked as well, taking the user deeper and deeper into the product.
c. A domain registration and hosting company provides URL and hosting for

BrowsePlay based video. This provides an easy way for video producers to put their new interactive video content on the web. The interactive video may have all the advantages of a website including Search Engine Optimization (SEO).
d. A digital video editing software suite includes the tools to add interactive titles and text to a finished video piece and then posts it to BrowsePlay, then straight to the web.
e. A real estate agent uses a GoPro to record a house room by room. Each element of a room's details can be zoomed at the users discretion. One and done shoot and easy play back.

In one aspect, BrowsePlay may provide HTML5 Secure Conditional Access, Authentication, Authorization, Tracking and Media Rights Management.
a. BrowsePlay may secure, authenticate and authorize application and media stream in browser based environments.
   1. Provides secure, smooth video streaming. This may be significant ability to deliver high quality video instantly without the need for a proprietary player, such as, e.g., no need for FlashTM, SilverlightTM, QuicktimeTM, WidevineTM and other proprietary video players. Moreover, there may be no need for multiple codecs on media sites. One codec plays to all standard browsers.
   2. Significance for media providers: lower infrastructure costs, greater customer experience. One and done site builds.
   3. Significance for App builders: Less need for executable environment for secure functions. BrowsePlay provides a standards based browser environment that provides enhanced functionality as app environment. This may be significant because lightweight Apps can be built totally on the back end with no need for client side software or constant updates.
      Updates are typically ongoing, transparent and continuous. Technical costs and risks may be greatly reduced.
      App functionality at the end of a link, a text, a web ad.
         i) Marketing costs can be greatly reduced.
         ii) Margins on app sales and subscriptions can be greatly enhance due to ability to exist outside the Apple, Android, Microsoft and Blackberry ecosystem which may average about 30% margin.
b. E-commerce applications:
   1. Fully interactive media and video that can feature products with links to purchase.
      Direct, instant cross platform links to full range of multimedia
         i) Media products including video may be more easily sold outside of major online retailer ecosystem perhaps saving about 30%.
         ii) All media including video can be sold direct from texts, emails, web ads, social media. Multiple layers of video interactivity are possible in the sale of physical goods.

In one aspect, the system and method herein may provide a service, perhaps at a first website on a first server for a content creator, producer or distributor of video content where transformation of the original video content into a format suitable for, e.g., mobile web applications is possible by using the processes described herein such as in relation to, e.g., one of more of the steps of FIGS. 2-6. A video file transformed by the processes herein may be mark-up (e.g., using HTML5) as appropriate and made available to others such as consumers, perhaps on a second server and/or at one or more second websites. The video may be accessed by others, e.g., consumers so that play back of the video may be reproduced replicating the original video without a need for standard video player or plugins, and permitting many new features to be applied to or along with the transformed video, as described herein. Such transformed video may be, e.g., marked up, written onto, and deep-linked, and may be generally searchable or indexed piece of web content on a website.

Additional Example BrowsePlay Applications and Verticals

BP unique characteristics enable “image based deep linking”, user control of zooming and sizing and delivery and manipulation of video that behaves just like an image. These key attributes bring new capabilities to html based displays. The following are exemplary non-limiting examples.

*Mobile Website Video:

With BP, mobile website designers can now incorporate video in a variety of ways. This capability is currently highly restricted, but BrowsePlay provides a way around the restrictions. The impact on the mobile web is immediate.

*Flexible Video Elements for any Website:

A web designer may use a video as a full screen backdrop for a web page and/or a mobile website and places the text and interactive links on top of the video, for a dramatic impact that is not seen on the web.

A web page may have a video as a full backdrop to the page and its showing a product in action. Certain parts of the product components may be clickable and interactive. If it was a car in motion, clicking the wheel could take the user to another video of a close-up of the wheel in action and the details of the braking system. Components of the braking system can be clicked as well, taking the user deeper and deeper into the product.

E-Commerce Inside of Video:

E-commerce may be added to each view, allowing for the component or components to be purchased. Any products in a video can be hot spotted for linking to a shopping cart page.

Educational Applications:

Videos that would take the user from the very large to the very small, or vice versa. An anatomy video resource would allow students to observe larger views of the human anatomy and then choose areas of interest where zooming-in, then discovering deeper views may become an interactive process. A wide view of the pancreas could be zoomed and linked all the way to an electron microscope view of the islets in action, then move even deeper into the cellular activity surrounding the process. This same deep linking process could be applied to all the sciences including, e.g., engineering, chemistry, physics, astronomy, medicine, and/or similar sciences. The continuity of large to small in a single real time image of any subject would provide new understanding of structure to students.

Non-Linear How-to Videos:

Many times the viewers of how-to videos already know many of the steps required for any given task. Aside from being able to pinch zoom into details, viewers could then use deep linking to quickly find out how to do a very specific task. Makers of “how-to” videos may have much more latitude and may create richer learning experiences, without having to do a myriad of close-ups and cutaways, providing a smooth flow for the view. Texts and graphics are layered on top of the video and are all deep linkable as well.

Surveillance and Security Applications:

Higher resolution imagery captured in a BrowsePlay video would be powerful, easier to use and broader in scope. Wider areas could be covered with one camera and give users the ability to easily zoom in on points of interest. In this way, fewer cameras could effectively cover more territory and still give needed detail for analysis.

Sports Applications:

Coaches may take wider angle high resolution videos of games and practices and easily zoom to individual players and their specific actions on a play. Sports announcers may have an easy to use new way to provide analysis and coverage, pinch zooming to areas of interest. Viewers at home on html devices may stop the video and pinch zoom on their own. Coverage of sporting events can ultimately be less expensive due to the ability of fewer cameras to successfully capture the same action.

Video Conferencing:

Many of the same attributes as educational use of deep linking. Also may save on cameras needed. For example, one wider shot with 8 people on a conference table would be enough resolution such that a viewer who wanted to get a closer look at a specific person presenting would just pinch zoom in. Materials used in presentations could be inserted into the video, such that the viewer could have control over either the view of the power point or the view of a specific person in the presentation. This is how the human eye works in direct proximity, thus making the meeting seem to be more “present.”

URL based Video Hosting:

A domain registration and hosting company may provide URL and hosting for BrowsePlay based video. This provides an easy way for video producers to put their new interactive video content on the web. The interactive video has all the advantages of a website including SEO. This use of the technology can be very disruptive to companies like YouTube, where their site is always the search center. A video with its own discrete URL may give the video owner all of the power of the website, including custom e-commerce.

Digital Video Editing Systems:

A digital video editing software suite may include the tools to add interactive titles and text to a finished video piece and then posts it to BrowsePlay, then straight to the web. This new feature would be added to existing editing software such as, e.g., Final Cut Pro, Adobe Aftereffects and even GoPro.

Real Estate Promotion:

A real estate agent may use a GoPro to record a house room by room. Each element of a room, details can be zoomed at the user's discretion. One and done shoot and easy play back. Even though the video could be looped, this method may give the viewer a sense of being in the property. The views may be deep linked and have sound and movement.

Distance Medicine:

A high 4k high resolution camera on an operating table broadcasting may give other doctors the ability to zoom in on the procedure and look where they want to . . . and still have great resolution.

Medical analytics regarding the procedure may be layered on top of the procedure and may be linked to for closer analysis. Medical records and other diagnostics like MRI and X-rays and be live linked to from the procedure.

Video Advertising:

BP may create an interactive video format for International Advertising Bureau (IAB) standard sizes that can be truly interactive and linkable from the ad unit versus a landing page. This flexibility for web designers may bring a new dimension to video advertising.

Games:

Games designers may need more interactive formats and flexibility as platforms and bandwidth improve—this also relates to the wearable idea below. Games may also be deep linked and ecommerce can easily be added.

Wearables:

As wearables emerge and ascend, there will be an acute need for a more flexible set of interactive video technologies to manage the UI and image rendering signals sent to the various screens. BP can emerge as an interactive wearable standard that links the inputs from the device feeds to user actions such as navigational gestures like pinching or stretching.

Military and Government Applications:

A big area for R&D by military may include drone and other unmanned VR tools. BP's interactivity could be a major benefit and allow for deeper either tactical effectiveness or training reality. Surveillance video may also be much enhanced.

Very Large Screen Displays:

Large wall sized video displays may take on new interactive capabilities with BP. Hot spotted mosaics and video in video deep linking may be combined with text and graphic overlays that are also interactive. These could be used for interactive ecommerce in retail environments or in kiosks. Large video advertising in airports could enable purchase of the products directly from the screen. Vending machine environments could be skinned with full screen video displays.

Example Code Segments for Supporting BrowsePlay Functionality

Non-limiting example code segments provided below illustrate several aspects for annotating video and for marking-up the video, according to principles of the disclosure. The following is also a non-limiting example of image data file code. The data can be placed in either the image data file or in a separate file. In the following non-limiting code example, the coordinates may be explicitly in the code. However, in actual use or production, these may be loaded from a server or other source. Generally, to track a new object in video for mark-up, the user may click-down (or may use other input selector) on a specific object when it appears on a screen, and may follow the objects around the screen with their mouse until they no longer wish to track it (or the object moves off-screen). Once the user has clicked-down on the object, the mouse coordinate position is stored for each frame of the video that plays while the mouse is clicked down. If the video was recorded at 24 frames per second, and the user tracks an object for 2 seconds, 48 coordinates (in the form of x,y) will be stored for this object. To finish tracking the object, the user simply releases the mouse button. A valid click on an item is detected using an algorithm where first the coordinate position of the click is determined. Then the frame count is determined. If, e.g., the video is 24 fps and the click occurs at 10 seconds, the frame count is 240. When the click coordinate and the frame count are known, image file database of tracked objects may be consulted. If any objects have been tracked at the time of that frame count, then their associated coordinates are compared to the click coordinate. If the coordinates match with an acceptable range, then the click is valid and the link associated with the matching object is opened.

Example Illustrative Code Segments:

var captureEnabled = false;
var capturedPaths = { };
var savedPaths = { };
savedPaths[“apple”] = JSON.parse(‘{“31”:[49.39068100358423,63.48600508905853],“32”:
[49.39068100358423,63.48600508905853],“33”:[49.39068100358423,63.48600508905853],“34”:
[49.39068100358423,63.48600508905853],“35”:[49.39068100358423,63.48600508905853],“36”:
[49.39068100358423,63.48600508905853],“37”:[49.39068100358423,63.48600508905853],“38”:
[49.39068100358423,63.61323155216285],“39”:[49.39068100358423,63.99491094147582],“40”:
[49.39068100358423,64.75826972010178],“41”:[49.31899641577061,65.2671755725191],“42”:
[49.24731182795699,65.2671755725191],“43”:[49.10394265232975,65.2671755725191],“44”:
[48.53046594982079,64.50381679389314],“45”:[48.45878136200717,64.24936386768448],“46”:
[48.38709677419355,64.24936386768448],“47”:[48.31541218637993,64.12213740458014],“48”:
[48.10035842293907,63.8676844783715],“49”:[48.028673835125446,63.61323155216285],“50”:
[47.24014336917563,62.468193384223916],“51”:[46.95340501792115,61.959287531806616],“52”:
[46.738351254480285,61.704834605597966],“53”:[46.52329749103943,61.45038167938931],“54”:
[46.37992831541219,61.32315521628499],“55”:[46.308243727598565,61.32315521628499],“56”:
[45.878136200716845,60.81424936386769],“57”:[45.73476702508961,60.43256997455471],“58”:
[45.376344086021504,60.17811704834606],“59”:[44.516129032258064,59.66921119592875],“60”:
[44.01433691756272,59.28753180661578],“61”:[44.01433691756272,59.28753180661578],“62”:
[43.01075268817204,59.16030534351145],“63”:[42.867383512544805,59.16030534351145],“64”:
[42.795698924731184,59.16030534351145],“65”:[42.795698924731184,59.16030534351145],“66”:
[42.795698924731184,59.16030534351145],“67”:[42.72401433691756,59.16030534351145],“68”:
[42.72401433691756,59.16030534351145],“69”:[42.72401433691756,59.16030534351145],“70”:
[42.72401433691756,59.16030534351145],“71”:[42.65232974910394,59.16030534351145],“72”:
[42.365591397849464,59.16030534351145],“73”:[40.57347670250896,59.16030534351145],“74”:
[39.928315412186386,59.16030534351145],“75”:[39.713261648745515,59.16030534351145],“76”:
[39.35483870967742,59.16030534351145],“77”:[38.494623655913976,59.16030534351145],“78”:
[38.13620071684588,59.16030534351145],“79”:[38.13620071684588,59.16030534351145],“80”:
[37.992831541218635,59.03307888040712],“81”:[37.992831541218635,58.778625954198475],“82”:
[37.992831541218635,58.778625954198475],“83”:[37.992831541218635,58.778625954198475],“84”:
[37.992831541218635,58.778625954198475],“85”:[37.992831541218635,58.778625954198475],“86”:
[37.992831541218635,58.778625954198475],“87”:[37.8494623655914,58.778625954198475],“88”:
[37.634408602150536,58.778625954198475],“89”:[36.91756272401434,58.905852417302796],“90”:
[36.12903225806451,59.16030534351145],“91”:[35.770609318996414,59.28753180661578],“92”:
[35.19713261648745,59.28753180661578],“93”:[34.551971326164875,59.28753180661578],“94”:
[34.40860215053764,59.28753180661578],“95”:[34.40860215053764,59.28753180661578],“96”:
[34.33691756272401,59.16030534351145],“97”:[34.33691756272401,59.16030534351145],“98”:
[34.33691756272401,59.16030534351145],“99”:[34.33691756272401,59.16030534351145],“100”:
[34.26523297491039,59.16030534351145],“101”:[34.26523297491039,59.16030534351145],“102”:
[33.763440860215056,59.16030534351145],“103”:[33.33333333333333,59.16030534351145],“104”:
[32.61648745519714,58.905852417302796],“105”:[31.684587813620073,58.651399491094146],“106”:
[31.25448028673835,58.524173027989825],“107”:[30.46594982078853,58.14249363867684],“108”:
[30.25089605734767,58.14249363867684],“109”:[30.107526881720432,58.01526717557252],“110”:
[30.107526881720432,58.01526717557252],“111”:[30.107526881720432,58.01526717557252],“112”:
[30.107526881720432,58.01526717557252],“113”:[30.107526881720432,58.01526717557252],“114”:
[30.107526881720432,58.01526717557252],“115”:[30.107526881720432,58.01526717557252],“116”:
[30.107526881720432,58.01526717557252],“117”:[30.107526881720432,58.01526717557252],“118”:
[29.820788530465954,58.01526717557252],“119”:[29.53405017921147,58.01526717557252],“120”:
[28.817204301075268,58.01526717557252],“121”:[28.673835125448026,58.01526717557252],“122”:
[28.602150537634408,58.01526717557252],“123”:[28.602150537634408,58.01526717557252],“124”:
[28.602150537634408,58.01526717557252],“125”:[28.602150537634408,58.01526717557252],“126”:
[28.602150537634408,58.01526717557252],“127”:[28.387096774193548,58.01526717557252],“128”:
[28.31541218637993,58.01526717557252],“129”:[27.670250896057347,58.01526717557252],“130”:
[27.025089605734763,57.88804071246819],“131”:[26.881720430107524,57.88804071246819],“132”:
[26.523297491039425,57.88804071246819],“133”:[26.523297491039425,57.88804071246819],“134”:
[26.021505376344084,57.88804071246819],“135”:[26.021505376344084,57.88804071246819],“136”:
[26.021505376344084,57.88804071246819],“137”:[26.021505376344084,57.88804071246819],“138”:
[26.021505376344084,57.88804071246819],“139”:[26.021505376344084,57.88804071246819],“140”:
[26.021505376344084,57.88804071246819],“141”:[26.021505376344084,57.88804071246819],“142”:
[26.021505376344084,57.88804071246819],“143”:[26.021505376344084,57.88804071246819],“144”:
[26.021505376344084,57.88804071246819],“145”:[26.021505376344084,57.88804071246819],“146”:
[26.021505376344084,57.88804071246819],“147”:[25.663082437275985,57.88804071246819],“148”:
[25.663082437275985,57.88804071246819],“149”:[24.874551971326163,57.88804071246819],“150”:
[24.731182795698924,57.88804071246819],“151”:[24.659498207885306,57.88804071246819],“152”:
[24.659498207885306,57.88804071246819],“153”:[24.516129032258064,57.88804071246819],“154”:
[24.229390681003586,57.88804071246819],“155”:[24.014336917562723,57.88804071246819],“156”:
[23.08243727598566,57.76081424936387],“157”:[22.867383512544805,57.63358778625955],“158”:
[22.795698924731184,57.63358778625955],“159”:[22.795698924731184,57.63358778625955],“160”:
[22.795698924731184,57.63358778625955],“161”:[22.795698924731184,57.63358778625955],“162”:
[22.795698924731184,57.63358778625955],“163”:[22.795698924731184,57.63358778625955],“164”:
[22.795698924731184,57.63358778625955],“165”:[22.795698924731184,57.63358778625955],“166”:
[22.795698924731184,57.63358778625955],“167”:[22.795698924731184,57.63358778625955],“168”:
[22.724014336917563,57.63358778625955],“169”:[22.078853046594983,57.63358778625955],“170”:
[22.078853046594983,57.63358778625955],“171”:[20.50179211469534,57.63358778625955],“172”:
[19.92831541218638,57.63358778625955],“173”:[19.6415770609319,57.63358778625955],“174”:
[19.426523297491038,57.63358778625955],“175”:[19.13978494623656,57.50636132315522],“176”:
[19.13978494623656,57.50636132315522],“177”:[19.13978494623656,56.87022900763359],“178”:
[19.13978494623656,56.87022900763359],“179”:[19.13978494623656,56.87022900763359],“180”:
[19.13978494623656,56.87022900763359],“181”:[19.13978494623656,56.87022900763359],“182”:
[19.13978494623656,56.87022900763359],“183”:[19.06810035842294,56.87022900763359],“184”:
[19.06810035842294,56.87022900763359],“185”:[17.491039426523297,56.87022900763359],“186”:
[16.845878136200717,56.87022900763359],“187”:[16.559139784946236,56.87022900763359],“188”:
[16.200716845878134,56.87022900763359],“189”:[16.129032258064516,56.74300254452926],“190”:
[16.057347670250895,56.74300254452926],“191”:[16.057347670250895,56.74300254452926],“192”:
[16.057347670250895,56.74300254452926],“193”:[16.057347670250895,56.74300254452926],“194”:
[16.057347670250895,56.74300254452926],“195”:[16.057347670250895,56.74300254452926],“196”:
[16.057347670250895,56.74300254452926],“197”:[15.985663082437277,56.74300254452926],“198”:
[15.627240143369175,56.74300254452926],“199”:[15.627240143369175,56.74300254452926],“200”:
[14.623655913978496,56.61577608142494],“201”:[14.480286738351255,56.61577608142494],“202”:
[14.193548387096774,56.61577608142494],“203”:[13.548387096774196,56.61577608142494],“204”:
[13.405017921146953,56.61577608142494],“205”:[13.405017921146953,56.61577608142494],“206”:
[13.405017921146953,56.61577608142494],“207”:[13.405017921146953,56.61577608142494],“208”:
[13.405017921146953,56.61577608142494],“209”:[13.405017921146953,56.61577608142494],“210”:
[13.405017921146953,56.61577608142494],“211”:[13.405017921146953,56.61577608142494],“212”:
[13.189964157706093,56.61577608142494],“213”:[13.189964157706093,56.61577608142494],“214”:
[11.54121863799283,56.61577608142494],“215”:[11.182795698924732,56.48854961832062],“216”:
[10.39426523297491,56.48854961832062],“217”:[10.32258064516129,56.36132315521628],“218”:
[10.32258064516129,56.234096692111954],“219”:[10.32258064516129,56.10687022900763],“220”:
[10.32258064516129,56.10687022900763],“221”:[10.32258064516129,56.10687022900763],“222”:
[10.32258064516129,56.10687022900763],“223”:[10.32258064516129,56.10687022900763],“224”:
[10.32258064516129,56.10687022900763],“225”:[10.03584229390681,56.10687022900763],“226”:
[10.03584229390681,56.10687022900763],“227”:[9.175627240143369,56.10687022900763],“228”:
[8.88888888888889,56.10687022900763],“229”:[7.813620071684587,56.10687022900763],“230”:
[7.813620071684587,56.10687022900763],“231”:[7.526881720430108,56.10687022900763],“232”:
[7.526881720430108,56.10687022900763],“233”:[7.526881720430108,56.10687022900763],“234”:
[7.526881720430108,56.10687022900763],“235”:[7.526881720430108,56.10687022900763],“236”:
[7.526881720430108,56.10687022900763],“237”:[7.526881720430108,56.10687022900763],“238”:
[7.311827956989248,56.10687022900763],“239”:[7.311827956989248,56.10687022900763],“240”:
[6.594982078853047,56.10687022900763],“241”:[6.164874551971327,56.10687022900763],“242”:
[6.093189964157706,56.10687022900763],“243”:[5.734767025089606,56.10687022900763],“244”:
[5.591397849462366,56.10687022900763],“245”:[5.591397849462366,56.10687022900763],“246”:
[5.591397849462366,56.10687022900763],“247”:[5.591397849462366,56.10687022900763],“248”:
[5.591397849462366,56.10687022900763],“249”:[5.591397849462366,56.10687022900763],“250”:
[5.591397849462366,56.10687022900763],“251”:[5.591397849462366,56.10687022900763],“252”:
[5.591397849462366,56.10687022900763],“253”:[5.591397849462366,56.10687022900763],“254”:
[5.448028673835125,56.10687022900763],“255”:[5.161290322580645,56.10687022900763],“256”:
[4.802867383512545,56.10687022900763],“257”:[4.516129032258064,55.85241730279898],“258”:
[4.301075268817205,55.72519083969466],“259”:[4.301075268817205,55.72519083969466],“260”:
[3.7275985663082443,55.72519083969466],“261”:[3.655913978494624,55.72519083969466],“262”:
[2.9390681003584227,55.72519083969466],“263”:[2.795698924731183,55.72519083969466],“264”:
[2.293906810035842,55.72519083969466],“265”:[2.2222222222222223,55.597964376590326],“266”:
[2.2222222222222223,55.597964376590326],“267”:[2.2222222222222223,55.597964376590326],“268”:
[2.2222222222222223,55.597964376590326],“269”:[2.2222222222222223,55.597964376590326],“270”:
[2.2222222222222223,55.597964376590326],“271”:[2.2222222222222223,55.597964376590326],“272”:
[2.2222222222222223,55.597964376590326],“273”:[2.2222222222222223,55.597964376590326],“274”:
[2.1505376344086025,55.597964376590326],“275”:[1.5770609318996418,55.597964376590326],“276”:
[1.3620071684587813,55.597964376590326],“277”:[1.3620071684587813,55.597964376590326],“278”:
[0.7168458781362007,55.597964376590326],“279”:
[0.35842293906810035,55.470737913486005],“280”:[0,55.343511450381676],“281”:
[−0.07168458781362007,55.343511450381676],“282”:
[−0.14336917562724014,55.343511450381676],“283”:[−0.21505376344086022,55.216284987277355]}’);
var currentCoordinate = null;
var mouseDown = false;
function checkPathHit(coordinate) {
var coordinateX = coordinate[0];
var coordinateY = coordinate[1];
var relativeWidth = (150.0 / $(“.player”).width( )) * 100.0;
var relativeHeight = (150.0 / $(“.player”).height( )) * 100.0;
var index = player.frameIndex;
for (var key in savedPaths) {

| var path = savedPaths[key]; | | |
|---|---|---|
| if (String(index) in path) { | /* A valid click on an item is detected using an algorithm */ | |
| var compareX = path[index][0]; | /* where first the coordinate position of the click is | */ |

| | |
|---|---|
| var compareY = path[index][1]; | /*determined. Then the frame count is determined. E.g., if the*/ |

| var leftBound = (compareX − (relativeWidth / 2.0)); /* video is 24 fps and the click occurs at */ | |
|---|---|
| var rightBound = (compareX + (relativeWidth / 2.0)); /* 10 seconds the frame count is 240. | */ |

```
  var topBound = (compareY − (relativeHeight / 2.0)); /* When the click coordinate and the frame */
  var bottomBound = (compareY + (relativeHeight / 2.0));/* count is known, image file database of */
```

| | |
|---|---|
| /* tracked objects is consulted. If any | */ |

| /* objects have been tracked at the time of that */ | |
|---|---|
| /* frame count, then their associated coordinates */ | |
| /* are compared to the click coordinate. If | */ |

```
  // console.log(String(leftBound) + “− ” + String(rightBound) + “ | ” + coordinateX); /*coordinates */
  // console.log(String(topBound) + “ − ” + String(bottomBound) + “ | ” + coordinateY); /* match with */
```

| | |
|---|---|
| /* an acceptable range, then the click is valid | */ |
| /* and the link associated with the matching | */ |
| /* object may be opened | */ |

if ((coordinateX >= leftBound) && (coordinateX <= rightBound) && (coordinateY >= topBound) &&

(coordinateY <= bottomBound)) {

| | | |
|---|---|---|
| $(“.web-frame”).attr(“src”, “http://en.wikipedia.org/wiki/” + key); | /* after coordinates & other | */ |

/* instructions are loaded, a dialog */

| /* box appears asking user to add a URL */ | |
|---|---|
| /* for the object to link. Once the user */ | |
| /* has linked an item, clicking on this item*/ | |
| /* during the video playback will cause the*/ | |
| /* link to be opened | */ |

```
  $(“.web-layer”).fadeIn(200);
  }
}
```

}
}
function storePathState( ) {

if (mouseDown == true) {

if (currentCoordinate != null) {
capturedPaths[String(player.frameIndex)] = currentCoordinate;

}

}
}
$(“.touch-layer”).on(“mousedown”, function(e) {

| | |
|---|---|
| /* This segment determines the actual size of the | */ |

| var x = e.pageX − 75; | /* hot spot and can be variable as well, depending on */ | |
|---|---|---|
| var y = e.pageY − 75; | /* the size of the tracked object | */ |

```
  var width = $(“.player”).width( );
  var height = $(“.player”).height( );
  var relativeX = ((x / width) * 100.0);
  var relativeY = ((y / height) * 100.0);
  currentCoordinate = [relativeX, relativeY];
  checkPathHit(currentCoordinate);
  if (captureEnabled == true) {
```

capturedPaths = { };
mouseDown = true;

$(“.touch-layer”).append(“<div class=‘capture point’ style=‘top: ” + relativeY + “%; left: ” +

relativeX +
“%;’></div>”);

}

});

| | | |
|---|---|---|
| $(“.touch-layer”).on(“mousemove”, function(e) { | /* This segment determines the actual size | */ |

| | | |
|---|---|---|
| if (mouseDown == true) { | /* of the hot spot and can be variable as | */ |

| | | |
|---|---|---|
| var x = e.pageX − 75; | /* well, depending on the size of the | */ |
| var y = e.pageY − 75; | /*tracked object. | */ |

var width = $(“.player”).width( );
var height = $(“.player”).height( );
var relativeX = ((x / width) * 100.0);
var relativeY = ((y / height) * 100.0);
$(“.capture”).css({“top”: relativeY + “%”, “left”: relativeX + “%”})
currentCoordinate = [relativeX, relativeY];

}

});
$(“.touch-layer”).on(“mouseup”, function( ) {

if (captureEnabled == true) {

| /* A dialog box at this stage asks the user to name the */ | |
|---|---|
| /* object being tracked. | */ |

```
  mouseDown = false;
  $(“.capture”).fadeOut(400).delay(400).remove( );
  if (Object.keys(capturedPaths).length > 0) {
```

var name = prompt(“What is the name of the object you tracked?”);
if (name) {

if (name in savedPaths) {
for (var key in capturedPaths) {

savedPaths[name][key] = capturedPaths[key];

```
  }
} else {
  savedPaths[name] = capturedPaths;
}
console.log(JSON.stringify(capturedPaths));
alert(“Saved Path”);
```

}

```
  }
  captureEnabled = false;
  currentCoordinate = null;
  }
```

});
if (captureEnabled) {

```
  setInterval(showPathFrames, (1000.0 / parseFloat(frameRate)));
  setInterval(storePathState, (1000.0 / parseFloat(frameRate)));
  alert(“After the video loads, click on an object you want to track and continue holding the mouse
  down while dragging along the object's path. Release the mouse to save the object path.”);
```

}

Although the foregoing description has been described by reference to various examples, it is to be understood that modifications and alterations in the structure and arrangement of those examples may be achieved by those skilled in the art and that such modifications and alterations can be practiced in the spirit of the appended claims. The examples herein are merely illustrative and are not meant to be an exhaustive list of all possible designs, examples or modifications of the disclosure.

What is claimed is:

1. A system for providing video comprising
a least one server platform configured to:
extract a plurality of video frames from a video file containing a video;
construct a second file comprising the plurality of video frames; and
a player embedded in a computing device configured to receive the second file and to playback the plurality of video frames therein at a predetermined rate to reproduce the video on a display, wherein the video frames are marked-up using a mark-up language

2. The system of claim 1, wherein the mark-up language comprises HTMLS.

3. (canceled)

4. The system of claim 1, wherein the mark-up is associated with at least one object within the video frames.

5. The system of claim 1, wherein the plurality of video frames contains at least one hotlink that is activatable at the computing device during playback of the video frames.

6. The system of claim 5, wherein the hotlink is configured to redirect upon activation to a website during playback of the video frames.

7. The system of claim 1, wherein the player playbacks the second file without a plug-in being required.

8. The system of claim 1, wherein the second file contains a header conveying at least one of: video speed indicating the predetermined rate to play back the plurality of video frames, a size of the second file.

9. The system of claim 1, wherein a portion of the reproduced video is zoomable during playback to create a zoomed video image.

10. The system of claim 1, wherein the zoomed video image continues playback at the predetermined rate.

11. A method of providing or creating a video comprising:
extracting a plurality of video frames from a video file containing a video; and
creating a second file comprising:
a header conveying a speed of the video; and
the plurality of extracted video frames,
wherein the extracted video frames are marked-up.

12. The method of claim 11, further comprising storing the extracted video frames in a plurality of first files, wherein each extracted video frame is stored in a separate first file.

13. The method of claim 11, wherein the mark-up extracted video frames are marked-up using HTML5.

14. (canceled)

15. (canceled)

16. The method of claim 11, further comprising embedding the second file in a website.

17. The method of claim 11, further comprising applying at least one hotlink to the plurality of extracted video frames.

18. The method of claim 11, wherein the plurality of extracted video files are configured to be zoomable during playback.

19. The method of claim 11, further comprising selecting at least one portion or at least one object within the video and marking-up the selected portion or selected object so that the selected potion or selected object is responsive when selected by a user during playback of the extracted plurality of video frames.

20-30. (canceled)

31. A method for providing video, the steps comprising:
selecting a video file;
uploading the video file for processing;
applying an ID to the second file;
extracting a plurality of still images from the video file;
storing each extracted image file creating N image files;
creating a header for the second file indicating video technical data including FPS;
storing first still image data in a second file;
calculating delta change information compared with next still image; and
appending the delta change information to the second file.

32. The method of claim 31, wherein the second file is marked-up using one of:
HTML5 and interactive links.

33-36. (canceled)

37. The system of claim 1, wherein the plurality of video frames comprise a plurality of still images.

38. The system of claim 1, wherein the plurality of video frames comprise a plurality of still images.
